(19) United States
(12) Patent Application Publication
(10) Pub. No.: US 2016/0226815 A1
(43) Pub. Date: Aug. 4, 2016

(54) SYSTEM AND METHOD FOR COMMUNICATING IN AN SSL VPN

(71) Applicant: HUAWEI TECHNOLOGIES CO., LTD., Shenzhen (CN)

(72) Inventors: Tao WAN, Ottawa (CA); Xingjun CHU, Ottawa (CA); Yapeng WU, Nepean (CA); Guoli YIN, Ottawa (CA)

(21) Appl. No.: 14/609,727

(22) Filed: Jan. 30, 2015

(51) Int. Cl. H04L 29/12

(52) U.S. Cl. CPC H04L 61/10; H04L 61/2007

(57) ABSTRACT

A virtual Internet Protocol (IP) address is assigned to a client device having a client IP address associated therewith. The virtual IP address is then mapped to the client IP address and to an identifier of a Secure Socket Layer (SSL) Virtual Private Network (VPN) tunnel. An incoming packet received through the SSL VPN tunnel and destined to a server device has the client IP address as its source address, which is in turn rewritten with the virtual IP address mapped to the client IP address, resulting in a modified incoming packet that is sent to the server device. An outgoing packet received from the server device for transmission to the client device has the virtual IP address as its destination address, which is in turn rewritten with the client IP address mapped to the virtual IP address, resulting in a modified outgoing packet that is forwarded into the tunnel.

### FIELD

Embodiments described herein generally relate to the field of Virtual Private Networks (VPNs), more particularly to communicating in Secure Sockets Layer (SSL) VPNs.

### BACKGROUND

Secure Sockets Layer (SSL) Virtual Private Networks (VPNs) provide users located within a public network (e.g., on the Internet) with secure access to remote services located within a private network. Typically, an SSL VPN consists of one or more VPN devices to which users connect over a public network, such as the Internet, using their Web browsers. Traffic between each user's Web browser and the VPN device(s) is encrypted with the SSL protocol.

One form of SSL VPN is network extension, by which partial or complete network access is provided to remote users. An SSL tunnel VPN network extension allows hosts in multiple fixed locations to establish secure connections with one another over the public network, such that computer resources from one internal network (e.g. an organization's private network) can be made available to users (e.g. employees) at other locations as if the users were physically located on the internal network. This, in turn, allows extension of the organization's network and eliminates the need for creating Web-specific portals for all applications that require remote access. Still, using SSL VPN network extension often increases routing complexity and can result in undesirable configuration and address management overhead.

There is therefore a need for an improved system and method for communicating in an SSL VPN.

### SUMMARY

In accordance with one aspect, there is provided a Secure Socket Layer (SSL) Virtual Private Network (VPN) server. The SSL VPN server is configured to assign a virtual Internet Protocol (IP) address to a selected client device having a client IP address associated therewith and map the virtual IP address to the client IP address and to a tunnel identifier of an SSL VPN tunnel.

In some example embodiments, the SSL VPN server may be configured to receive through the SSL VPN tunnel a first incoming packet indicative from the selected client device, the first incoming packet having the client IP address as its source address and destined to a server device in communication with the SSL VPN server. The SSL VPN server may also be configured to rewrite the source address of the first incoming packet with the virtual IP address mapped to the client IP address, thereby obtaining a first modified incoming packet, and send the first modified incoming packet to the server device.

In some example embodiments, the SSL VPN server may be configured to receive from a server device in communication with the SSL VPN server an outgoing packet having the virtual IP address as its destination address, the outgoing packet for transmission to the selected client device over the SSL VPN tunnel, rewrite the destination address of the outgoing packet with the client IP address mapped to the virtual IP address, thereby obtaining a modified outgoing packet, and forward the modified outgoing packet into the SSL VPN tunnel.

In some example embodiments, the SSL VPN server may be configured to maintain a virtual address space comprising a plurality of previously-generated virtual IP addresses and select an available one of the plurality of virtual IP addresses for assigning the virtual IP address.

In some example embodiments, the SSL VPN server may be configured to dynamically generate the virtual IP address in real-time.

In some example embodiments, the SSL VPN server may be configured to map the virtual IP address to the client IP address comprising an IP address of a client machine in communication with an SSL VPN device to which the SSL VPN tunnel is established.

In some example embodiments, the SSL VPN server may be configured to map the virtual IP address to the client IP address comprising an IP address of a Network Address Translation (NAT) device in communication with an SSL VPN device to which the SSL VPN tunnel is established.

In some example embodiments, the SSL VPN server may be configured to receive through the SSL VPN tunnel, after receiving the first incoming packet, a second incoming packet from the selected client device, the second incoming packet destined to the server device and having the client IP address as its source address, and rewrite the source address of the second incoming packet with the virtual IP address.

In some example embodiments, the SSL VPN server may be configured to receive through the SSL VPN tunnel, after receiving the first incoming packet, a second incoming packet from another client device, the second incoming packet destined to the server device, the source address of the second subsequent incoming packet differing from the client IP address of the selected client device. The SSL VPN server may be configured to assign a new virtual IP address to the other client device and create a new mapping between the new virtual IP address, the tunnel identifier, and the source address of the second incoming packet, and the SSL VPN server may be configured to rewrite the source address of the second incoming packet with the new virtual IP address.

In accordance with another aspect, there is provided a method for communicating in an SSL VPN. The method comprises assigning a virtual IP address to a selected client device having a client IP address associated therewith and mapping the virtual IP address to the client IP address and to a tunnel identifier of an SSL VPN tunnel.

In some example embodiments, the method may further comprises receiving through the SSL VPN tunnel a first incoming packet from the selected client device, the first incoming packet having the client IP address as its source address and destined to a server device in communication with the SSL VPN server. The source address of the first incoming packet is rewritten with the virtual IP address mapped to the client IP address, thereby obtaining a first modified incoming packet, and the first modified incoming packet is sent to the server device.

In some example embodiments, an outgoing packet may be received from a server device in communication with the SSL VPN server, the outgoing packet for transmission to the selected client device over the SSL VPN tunnel, the outgoing packet having the virtual IP address as its destination address. The destination address of the outgoing packet is rewritten with the client IP address mapped to the virtual IP address, thereby obtaining a modified outgoing packet, and the modified outgoing packet forwarded into the SSL VPN tunnel.

In some example embodiments, the method may include maintaining a virtual address space comprising a plurality of previously-generated virtual IP addresses and selecting an available one of the plurality of virtual IP addresses to assign the virtual IP address.

In some example embodiments, the method may include dynamically generating the virtual IP address in real-time.

In some example embodiments, the SSL VPN tunnel may be established to an SSL VPN device and the virtual IP address mapped to the client IP address comprising an IP address of a client machine in communication with the SSL VPN device.

In some example embodiments, the SSL VPN tunnel may be established to an SSL VPN device and the virtual IP address mapped to the client IP address comprising an IP address of Network Address Translation (NAT) device in communication with the SSL VPN device.

In some example embodiments, the method may include receiving through the SSL VPN tunnel, after receiving the first incoming packet, a second incoming packet from the selected client device, the second incoming packet destined to the server device and having as its source address the client IP address, and rewriting the source address of the second incoming packet with the virtual IP address.

In some example embodiments, the method may include receiving through the SSL VPN tunnel, after receiving the first incoming packet, a second incoming packet from another client device, the second incoming packet destined to the server device, the source address of the second incoming packet differing from the client IP address of the selected client device. The method may comprise assigning a new virtual IP address to the other client device and creating a new mapping between the new virtual IP address, the tunnel identifier, and the source address of the second incoming packet, and rewriting the source address of the second incoming packet with the new virtual IP address.

In some example embodiments, an incoming packet may be received through the SSL VPN tunnel as encapsulated with the SSL protocol and the method may include decapsulating the incoming packet prior to rewriting its source address and encapsulating the modified outgoing packet with the SSL protocol prior to forwarding into the SSL VPN tunnel.

In accordance with another aspect, there is provided a computer readable medium having stored thereon program code executable by a processor for assigning a virtual IP address to a client device having a client IP address associated therewith and mapping the virtual IP address to the client IP address and to a tunnel identifier of an SSL VPN tunnel.

Many further features and combinations thereof concerning the present improvements will appear to those skilled in the art following a reading of the instant disclosure.

### DESCRIPTION OF THE FIGURES

In the figures,

FIG. 1 is a schematic diagram of a Secure Sockets Layer (SSL) Virtual Private Network (VPN) system, in accordance with one embodiment;

FIG. 2a is a block diagram of the SSL VPN server of FIG. 1;

FIG. 2b is a block diagram showing an exemplary application running on the processor of FIG. 2a, in accordance with one embodiment;

FIG. 2c is a block diagram of the address remapping module of FIG. 2b, in accordance with one embodiment;

FIG. 3 is a flow diagram depicting establishment of an SSL VPN, in accordance with the embodiment of FIG. 1;

FIG. 4 is a schematic diagram of an SSL VPN system, in accordance with another embodiment;

FIG. 5 is a flow diagram depicting establishment of an SSL VPN, in accordance with the embodiment of FIG. 4;

FIG. 6a illustrates a flowchart of a method for communicating in an SSL VPN, in accordance with one embodiment;

FIG. 6b illustrates a flowchart of the step of FIG. 6a of receiving packet(s) through an established SSL VPN tunnel, in accordance with one embodiment; and

FIG. 6c illustrates a flowchart of the step of FIG. 6a of sending outgoing packet(s) through the established SSL VPN tunnel, in accordance with one embodiment.

It will be noted that throughout the appended drawings, like features are identified by like reference numerals.

### DETAILED DESCRIPTION

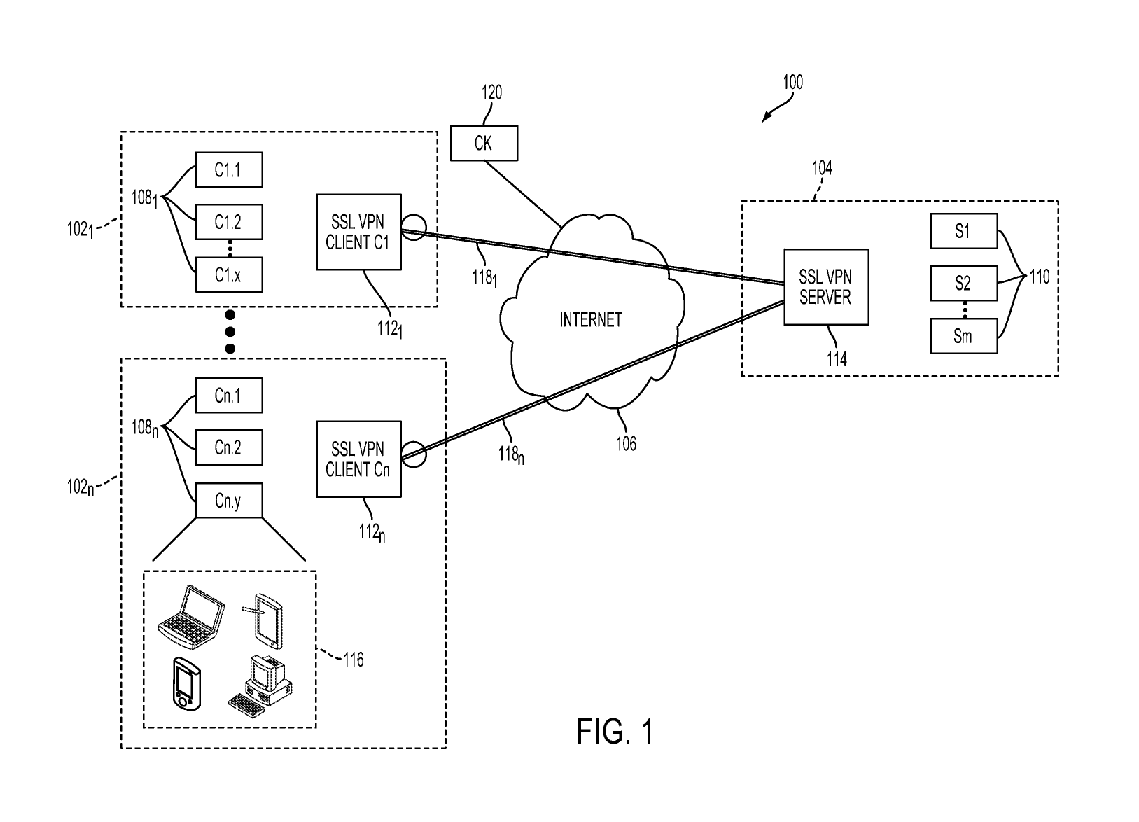

Referring now to FIG. 1, a Secure Sockets Layer (SSL) Virtual Private Network (VPN) system 100, in accordance with a first embodiment, will now be described. The illustrated system 100 uses network extension. The system 100 comprises one or more remote sites or networks (e.g. Local Area Networks (LANs)) as in 102₁, . . . , 102ₙ connected to a private network 104 (e.g. an organization's network) over a public network 106, such as the Internet. A plurality of client machines as in 108₁, . . . , 108ₙ are located within each remote (or client) network as in 102₁, . . . , 102ₙ, with one or more of the client machines 108₁, . . . , 108ₙ attempting to gain remote access to one or more servers 110 located in the private (or server) network 104.

The servers 110 provide services or resources requested by the originating client machines and may include, but are not limited to, Web servers, application servers, file servers, authentication servers, or the like. Remote access to the servers 110 is provided using SSL VPN. For this purpose, a first SSL VPN device (referred to herein as SSL VPN client) 112₁, . . . , 112ₙ is provided at an edge of each remote network 102₁, . . . , 102ₙ while a second SSL VPN device (referred to herein as SSL VPN server) 114 is provided at an edge of the private network 104. Each first SSL VPN device 112₁, . . . , 112ₙ allows one or more of the client machines 108₁, . . . , 108ₙ located within its network 102₁, . . . , 102ₙ to access the multiple servers 110. For example, the SSL VPN device 112₁ provides the client machines 108₁ access any one of the servers 110.

It should be understood that while the client machines 108₁, . . . , 108ₙ located in a given private network (102₁, . . . , 102ₙ are presented herein and described as being separate entities from the SSL VPN client located in the given private network 112₁, . . . , 112ₙ, they may be combined as a single entity. For example, the SSL VPN client 112₁ may be installed either as a plug-in in the Web browser of client machine 108₁ or as a program on the client machine's system. In another embodiment, a single physical server could host the SSL VPN client 112₁ and multiple virtual machines. Similarly, the servers 110 may be integrated with the SSL VPN server 114. It should also be understood that several SSL VPN servers 114 may be provided within the private network 104 to achieve load balancing or failover (in case of failure or abnormal termination of a connection to a given SSL VPN server).

Each one of the originating client machines 108₁, . . . , 108ₙ may comprise any one of a plurality of devices 116. The devices 116 may include any device, such as a personal computer (PC), a tablet, a smart phone, or the like, configured to communicate over the network 106. For this purpose, each device 116 may have a network interface in order to communicate with other components, to access and connect to network resources, and perform other computing applications by connecting to a network (or multiple networks), as in network 106, capable of carrying data. The devices 116 may or may not be controlled or managed by an organization whose remote resources 110 users wish to access. Users of the devices 116 may include, for example, employees in remote offices, mobile users, business partners, and customers. Therefore, a client machine 108₁, . . . , 108ₙ may gain SSL VPN access from any location, including, but not limited to, home, a remote branch office, an airport, a hotel room, or the like, so long as the location has connectivity to the network 106 and the client machine 108₁, . . . , 108ₙ is capable of communicating with the particular SSL VPN client as in 112₁, . . . , 112ₙ.

Upon a given one of the client machines, for example 108₁, requesting (e.g. by using their Web browser) establishment of an SSL VPN connection for accessing one of the servers 110, a semi-permanent point-to-point tunnel 118₁ is then created between the SSL VPN client 112₁ present in the remote network 102₁, where the originating client machine 108₁ is located, and the SSL VPN server 114 located in the private network 104. Other tunnels, for example tunnel 118ₙ, may also be created to provide client machines located in other remote networks, e.g. any one of the client machines 108ₙ located in remote network 102ₙ, access to the servers 110. Once a tunnel 118₁ is established, all traffic between the originating client machines 108₁ and the servers 110 is encrypted using the SSL protocol and routed through the established tunnel 118₁. Any client machine 120 that is not located within one of the remote networks 102₁, . . . , 102ₙ will not be able to communicate with the servers 110 over any one of the established tunnels 118₁, . . . , 118ₙ upon accessing the public network 106.

It can be seen from FIG. 1 that when network extension is used, the SSL VPN server 114 is typically required to assign to each SSL VPN client as in 112₁, . . . , 112ₙ an IP address from a common address space (or pool) in order for packets to be properly routed back to their destination. In particular, the client side needs to be configured with addresses retrieved from the server side. For example, SSL VPN client 112₁ needs to configure a given IP address obtained from the SSL VPN server 114 and all packets from the SSL VPN client 112₁ have to use the given IP address as their source address in order to be properly routed towards the server side through the SSL VPN. However, this increases configuration and management overhead as the SSL VPN server 114 needs to maintain an address pool for the SSL VPN clients 112₁, . . . , 112ₙ to use and has to perform address allocation and management for all SSL VPN clients 112₁, . . . , 112ₙ. It is therefore desirable to remove the requirement for such address allocation and management at the server side. One hypothetical solution to avoiding address allocation and management for all SSL VPN clients 112₁, . . . , 112ₙ from being performed at the SSL VPN server 114 may be to use the public IP address of the SSL VPN clients 112₁, . . . , 112ₙ for routing. In this case, packets destined to the public IP address of the SSL VPN clients 112₁, . . . , 112ₙ will be sent to the SSL VPN server 114 by the servers 110 for transmission towards the originating client machines 108₁, . . . , 108ₙ via the established SSL tunnel(s) 118₁, . . . , 118ₙ.

Still, issues may arise in this case if the SSL VPN clients 112₁, . . . , 112ₙ are located behind Internet Service Provider (ISP) Network Address Translation (NAT) devices (not shown) from different ISPs. Indeed, the public IP addresses of the SSL VPN clients 112₁, . . . , 112ₙ would in fact be private and may even be in conflict (e.g. the same public IP Address being used for different SSL VPN clients), thereby preventing the SSL VPN server 114 from knowing which SSL VPN tunnel 118₁, . . . , 118ₙ to select for a given outgoing packet destined to a given originating client machine 108₁, . . . , 108ₙ. Indeed, no routing table would exist in this case and packets exiting the SSL VPN server 114 would therefore be dropped. In addition, even if the SSL VPN server 114 knows which SSL VPN tunnel 118₁, . . . , or 118ₙ to select and uses the public IP address from the ISP NAT device for routing, the SSL VPN client 112₁, . . . , 112ₙ that serves as the tunnel's endpoint will not know how to forward the outgoing packet that exits the SSL VPN tunnel 118₁, . . . , or 118ₙ because the packet's destination address will be the public IP address from the ISP NAT device. Moreover, all packets destined to a given ISP public IP address (i.e. packets for all clients behind a given ISP NAT device) would be sent through the same SSL VPN tunnel 118₁, . . . , 118ₙ. As a result, other client machines, which have not established an SSL VPN tunnel but are located behind the same ISP NAT device as client machines with which the SSL VPN tunnel 118₁, . . . , or 118ₙ is established, will see their traffic routed through the tunnel 118₁, . . . , or 118ₙ even if this should not occur. It can therefore be seen that the hypothetical solution of using the public IP address of the SSL VPN clients 112₁, . . . , 112ₙ for routing fails. There is therefore a need for another solution to the above-mentioned issues that arise when network extension is used.

As will be discussed further below, using the proposed SSL VPN server (and corresponding communication method) allows to overcome the above-mentioned issues by implementing server-side NAT for SSL VPN clients as in 112₁, . . . , 112ₙ and allowing SSL VPN to be established without requiring the SSL VPN clients 112₁, . . . , 112ₙ to share a common address space or address configuration to be performed at the client side.

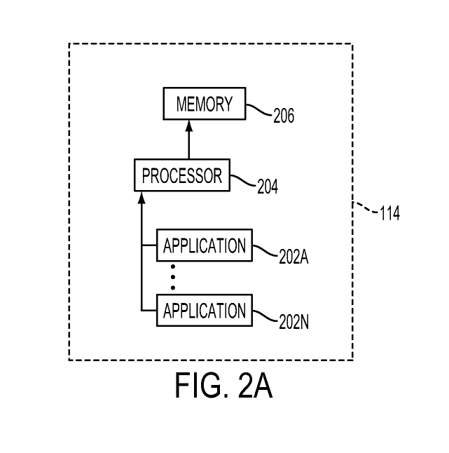

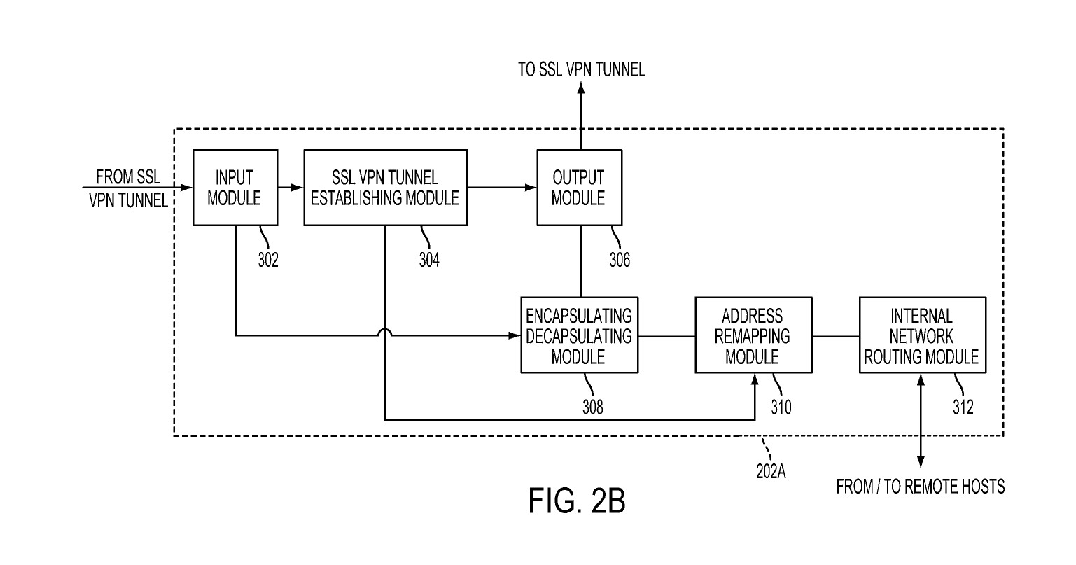

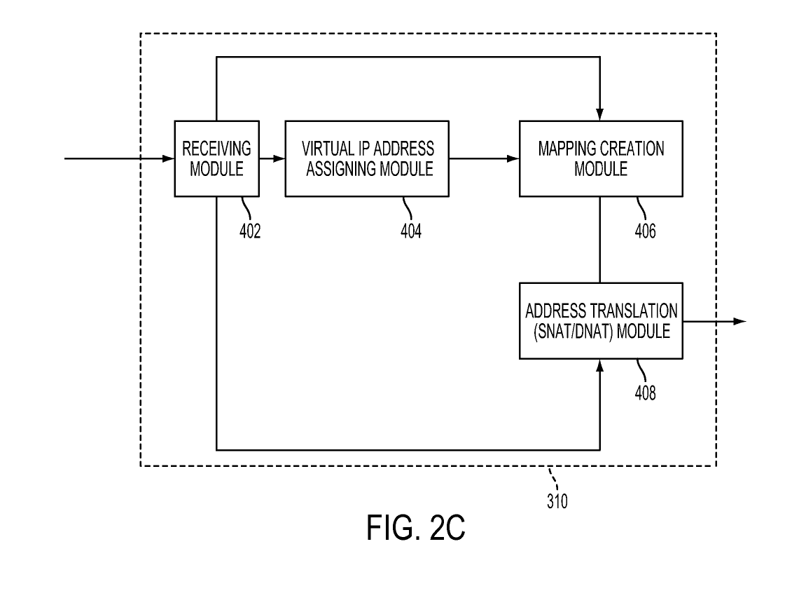

Referring now to FIG. 2a, the illustrated SSL VPN server 114 comprises, amongst other things, a plurality of applications 202A . . . 202N running on a processor 204 coupled to a memory 206. It should be understood that while the applications 202A . . . 202N presented herein are illustrated and described as separate entities, they may be combined or separated in a variety of ways. Although not illustrated, it should also be understood that each SSL VPN client (references 112₁, . . . , 112ₙ in FIG. 1) may also comprise, amongst other things, a plurality of applications running on a processor coupled to a memory.

The memory 206 accessible by the processor 204 may receive and store data. The memory 206 may be a main memory, such as a high speed Random Access Memory (RAM), or an auxiliary storage unit, such as a hard disk, flash memory, or a magnetic tape drive. The memory 206 may be any other type of memory, such as a Read-Only Memory (ROM), Erasable Programmable Read-Only Memory (EPROM), electrically-erasable programmable read-only memory (EEPROM), Ferroelectric RAM (FRAM), or optical storage media such as a videodisc or a compact disc. The processor 204 may access the memory 206 to retrieve data. The processor 204 may be any device that can perform operations on data. Examples are a central processing unit (CPU), a front-end processor, a microprocessor, a field programmable gate array (FPGA), a reconfigurable processor, and a network processor. The applications 202A . . . 202N are coupled to the processor 204 and configured to perform various tasks.

FIG. 2b illustrates an embodiment of an application 202A running on the processor 204. The illustrated application 202A comprises an input module 302, an SSL VPN tunnel establishing module 304, an output module 306, an encapsulating/decapsulating module 308, an address remapping module 310, and an internal network routing module 312. As can be seen in FIG. 2c, the address remapping module 310 comprises a receiving module 402, a virtual Internal Protocol (IP) address assigning module 404, a mapping creation module 406, and an address translation (Source Network Address Translation (SNAT)/Destination Network Address Translation (DNAT)) module 408.

When requesting access to a server (reference 110 in FIG. 1), a client machine (e.g. client machine 108₁ in FIG. 1) first requests, e.g. through the SSL VPN client 112₁ located in its remote network 102₁, establishment of an SSL VPN connection with the SSL VPN server 114 and sends, upon successful completion of an authentication process, an access request to the server 110 over the established connection. This may be done by a user inputting the Uniform Resource Locator (URL) address of the SSL VPN server 114 on the client machine 108₁ (e.g. the client machine) and entering a Web interface of the SSL VPN server 114 to view available servers 110 and select a server to access. The input data (e.g. request data, authentication data) received from the client side for establishment of the SSL VPN tunnel arrives at the input module 302, which in turn sends the input data to the SSL VPN tunnel establishing module 304 for processing. The SSL VPN tunnel establishing module 304 may then authenticate the SSL VPN client 112₁, e.g. using a certificate or username/password combination input by the user. It should be understood that the identity of the SSL VPN server 114 may also be authenticated at the client side using a certificate of the SSL VPN server 114. Upon completion of the authentication process, the SSL VPN tunnel establishing module 304 may then establish an SSL VPN tunnel 118₁ between the SSL VPN client 112₁ and the SSL VPN server 114 in a manner known to those skilled in the art. The established tunnel has associated therewith a unique identifier (e.g. session identifier, user identifier, and socket identifier, among others) that may be used to determine which tunnel is to be used for transmission. The SSL VPN tunnel establishing module 304 may then communicate with the output module 306 for causing presentation (e.g. on the client machine 108₁) of data indicative of successful establishment of the SSL VPN tunnel. The output module 306 may also be used to present the Web interface of the SSL VPN server 114 to the user.

After establishment of the SSL VPN tunnel, the SSL VPN tunnel establishing module 304 communicates with the address remapping module 310 for causing generation of a virtual (or logical) IP address that is unique for the client (e.g. client machine 108₁), and accordingly unique per combination of tunnel (e.g. SSL VPN tunnel 118₁) and client IP address, as will be discussed further below. In particular, instructions to generate the virtual IP address may be received at the receiving module 402 of the address remapping module 310 and sent to the virtual IP address assigning module 404, which generates a virtual IP address that is unique per SSL VPN client 112₁, . . . , 112ₙ. As used herein, a virtual IP address is an IP address, which is internal to the SSL VPN server 114 and that is not bound assigning a single physical interface and that one cannot route directly to. The virtual IP address assigning module 404 may create the virtual IP address dynamically in real-time, e.g. “on the fly” as soon as the SSL VPN tunnel is established. In order to reduce the number of forwarding rules injected into the system, the virtual IP address assigning module 404 may alternatively use a virtual address space (or pool). In this case, the virtual address space may be stored in memory and may comprise a range of previously-generated virtual IP addresses that the SSL VPN server 114 makes available for establishing the SSL VPN. When a tunnel is established, the virtual IP address assigning module 404 may select for the SSL VPN client 112₁, . . . , 112ₙ an available (i.e. not currently used) virtual IP address among the plurality of virtual IP addresses.

Once the virtual IP address has been created, the mapping creation module 406 is used to map the virtual IP address to the established SSL tunnel (e.g. to the unique identifier associated therewith) as well as to the client's IP address (e.g. the IP address, private or public, of the client machine as in 108₁). A mapping that is unique per combination of client IP address and tunnel is thereby created. For example, two same client IP addresses from two different tunnels are mapped to two different virtual IP addresses, and therefore different mappings are created. Also, two different client IP addresses from a same tunnel are mapped to two different virtual IP addresses, and therefore different mappings are also created. The mapping may be stored by the mapping creation module 406 in memory (reference 206 in FIG. 2a) for subsequent use. It should be understood that the mapping may be provided in any suitable format, such as a table having several entries.

Rather than being created upon establishment of the SSL tunnel, the mapping may also be created after a first packet forwarded from the client side exits the SSL tunnel and is received at the server side. Since the mapping depends on both the client IP address and its associated tunnel, mappings may be pre-calculated and/or cached for later use as long as it is possible to predict client IP address that will be used at the client IP side. Also, provided it is possible to obtain knowledge of the tunnel identifier associated with the SSL tunnel that will be used for routing, the mappings may be pre-calculated and/or cached for later use before the SSL tunnel is created. Still, it may be preferable to create the mapping once a first packet is received, to avoid having to predict the client IP addresses, as discussed further below. In this case, the packet may be received at the input module 302 and sent to the encapsulating/decapsulating module 308 where the packet is decapsulated to remove the header(s) thereof. The decapsulated packet is then sent to the address remapping module 310 where it is received at the receiving module 402 and passed to the mapping creation module 406. The mapping creation module 406 may then determine a source IP address of the decapsulated packet. As will be discussed further below, the source IP address (i.e. the client IP address, as used herein) may be the IP address of the originating client machine (e.g. client machine 108₁) or the IP address of a NAT device (not shown) the client machine is located behind. The mapping creation module 406 then maps the virtual IP address to the established SSL tunnel and to the source IP address obtained from the decrypted packet, e.g. the client's IP address.

It should be understood that, in one embodiment, the mapping for a given client is only performed once and need not be performed again for subsequent packets from the same client. Indeed, upon a packet exiting the tunnel being decapsulated, the receiving module 402 may query the memory to determine whether a mapping already exists that has the packet's source IP address (i.e. the client IP address) as an entry. If this is not the case, e.g. no table entry is found for the source IP address, as may be the case when a different client requests access to the server, the mapping creation module 406 may be invoked where a new virtual IP address may be created for the client and a new mapping entry created for use by the address translation module 408 in performing address translation for this client. Otherwise, if a table entry is found, the previously-created mapping is retrieved from memory for use by the address translation module 408 in performing address translation for the packet.

After creation of the mapping, a static route may be configured and automatically inserted into the routing process for the servers 110, thereby implementing Reverse Route Injection (RRI). The static route may link the virtual IP address to the tunnel identifier and thereby indicate that, any packet received from the servers 110 and whose destination address is the virtual IP address should be routed to the SSL VPN server 114. In other words, the static route is used to configure the SSL VPN server 114 as the next hop of packets destined to the virtual IP address. This proves useful to ensure proper routing of packets when several SSL VPN tunnels are established with the same SSL VPN server, or when several SSL VPN servers are used. The static route information may then be propagated to the servers 110, allowing them to determine the appropriate SSL VPN device 114 to which to send outgoing traffic. This may prove particularly useful in embodiments where multiple SSL VPN servers are provided in the private network 104. Once an outgoing packet is received by the SSL VPN server 114, the mapping module 406 may then select an SSL VPN tunnel for the packet, as well as its original destination address, based on its virtual IP address.

After establishment of the SSL VPN tunnel 118₁, incoming traffic exiting the tunnel 118₁ is received at the input module 302 and sent to the encapsulating/decapsulating module 308 for removal of header(s), i.e. decapsulation. The decapsulated packets are then sent to the address remapping module 310 where they are received at the receiving module 402. When the receiving module 402 determines that no mapping exists for the packets, the packets are sent to the mapping creation module 406, as discussed above. When the receiving module 402 determines that a mapping exists for the packets, the packets are sent to the address translation module 408, which performs address translation in accordance with the mapping. In particular, the address translation module 408 may determine from the mapping (e.g. retrieved from memory or obtained from the mapping creation module 406 directly) the virtual IP address corresponding to the source IP address (e.g. the client IP address) of the packet. The address translation module 408 then performs SNAT, i.e. rewrites the packet's source IP address by replacing the client IP address with the virtual IP address for the client.

The address translation module 408 then passes the modified packet (having the virtual IP address as its source address and the IP address of the server 110 as its destination address) to the internal network routing module 312, which resolves the client request from the received packet and forwards the packets to the server 110 requested by the client. It should be understood that, in some embodiments (e.g. if no security mechanism is provided in the network), the internal network routing module 312 may forward the client request to the server 110 in plain text. The server 110 in turn generates an outgoing packet having the virtual IP address as its destination address (and the IP address of the server 110 as its source address) and sends the outgoing packet to the SSL VPN server 114 where the outgoing packet is received at the internal network routing module 312. It should be understood that, in some embodiments, the server's reply may be sent to the SSL VPN server 114 in plain text identifying the source and destination addresses. It should also be understood that, in some embodiments, a gateway or other suitable device may be provided that receives outgoing packets from servers 110 and routes the outgoing packets to the SSL VPN server 114.

The internal network routing module 312 then passes the packet to the address remapping module 310 where the outgoing packet is received at the receiving module 402 and sent to the address translation module 408 where DNAT will be performed. For this purpose, the address translation module 408 queries the memory (or accesses the mapping creation module 406) to determine whether a mapping exists that has the destination IP address (i.e. the virtual IP address) as an entry. If this is not the case, the packet is dropped or rejected because the SSL VPN server 114 does not know how to route the packet. For example, no mapping may be found if an entry in memory has been maliciously deleted. Otherwise, the address translation module 408 determines from the mapping the client IP address corresponding to the virtual IP address and performs DNAT on the outgoing packet, i.e. rewrites the packet's destination IP address by replacing the virtual IP address with the client IP address. In this manner, the outgoing packet can be correctly addressed to the client machine 108₁. The address translation module 408 then sends the modified outgoing packet to the encapsulating/decapsulating module 308 where the packet is encapsulated and sent to the output module 306 for forwarding into the SSL VPN tunnel 118₁ (according to the previously-created static route) towards the client machine 108₁ having requested the service.

It should be understood that while both incoming packets (i.e. packets received at the SSL VPN server 114 through the SSL VPN tunnel 118₁) and outgoing packets (forwarded by the SSL VPN server 114 into the SSL VPN tunnel 118₁) are presented herein as being processed using the same modules (e.g. the encapsulating/decapsulating module 308 and the internal network routing module 312), a first set of modules may be used for incoming packets while a second set of modules is used for outgoing packets. For example, incoming packets may be handled by a first internal network routing module while outgoing packets may be handled by a second internal network routing module. Also, a decapsulating module may be used to decapsulate incoming packets while a separate encapsulating module may be used for encapsulating outgoing packets. Other embodiments may apply.

It should also be understood that, in some embodiments, the SSL VPN tunnel 118₁ need not be established in response to receipt of an incoming packet from a client device. Indeed, the SSL VPN server 114 may be configured as a control unit capable of establishing the SSL VPN tunnel 118₁ and initiating, through the established tunnel, contact with the client side, e.g. to determine whether the client side has service for the server side. Thus, the server side may send through the SSL VPN tunnel 118₁ outgoing traffic towards the client side even if incoming traffic has not yet been received from the client side.

Other variants to the configurations of the input module 302, SSL VPN tunnel establishing module 304, output module 306, encapsulating/decapsulating module 308, address remapping module 310, and internal network routing module 312 may also be provided and the example illustrated is simply for illustrative purposes.

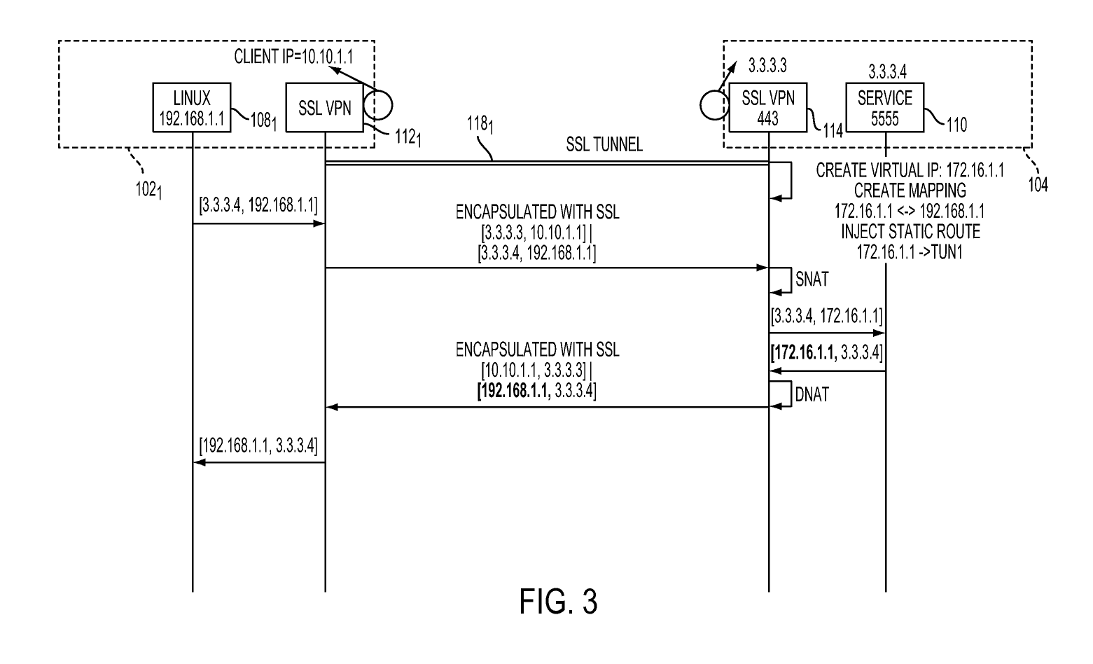

Referring now to FIG. 3, an example of SSL VPN establishment in accordance with a first embodiment will now be described. A user sitting behind a client machine 108₁ in a remote network 102₁ (e.g. a home network, branch office network, or the like) requests access to a server 110 located in a private network 104 (e.g. a main office network), the client machine 108₁ and the server 110 respectively having private (or “real”) IP addresses 192.168.1.1 and 3.3.3.4. Still, it should be understood that the client IP address may be a public address. For this purpose, an SSL VPN tunnel 118₁ is first established between an SSL VPN client 112₁ located at an edge of the remote network 102₁ and an SSL VPN server 114 located at an edge of the private network 104. The SSL VPN server 114 creates a virtual IP address (172.16.1.1) unique per combination of client IP address and SSL tunnel 118₁ and creates a mapping between the virtual IP address, the IP address of the client machine 108₁, and the SSL tunnel 118₁. The SSL VPN server 114 further creates a static route that is automatically inserted into the routing process for the server 110 and which indicates that the SSL tunnel 118₁ (identified by the identifier “TUN1” in the illustrated example) is to be used for routing any packet received from the server 110. Confirmation of establishment of the SSL tunnel 118₁ may be sent to the client side and the client machine 108₁ then sends into the remote network 104 a packet having as its source address the IP address (192.168.1.1) of the client machine 108₁ and as its destination address the IP address (3.3.3.4) of the server 110. The packet is received at the SSL VPN client 114, where it is encapsulated with the SSL protocol and routed into the SSL tunnel 118₁.

Upon exiting the SSL tunnel 118₁, the encapsulated packet is received at the SSL VPN server 114, where it is decapsulated. The SSL VPN server 114 accordingly identifies the IP address (192.168.1.1) of the client machine 108₁ as being the packet's source address and queries the memory to determine from the mapping the virtual IP address (172.16.1.1) that corresponds to the identified client IP address. The SSL VPN server 114 then rewrites the packet's source address by replacing the client IP address with the virtual IP address (SNAT). The resulting packet is then sent to the server 110, which accordingly generates an outgoing packet having as its source address the IP address (3.3.3.4) of the server 110 and as its destination address the virtual IP address (172.16.1.1). The outgoing packet is then sent by the server 110 to the SSL VPN server 114. The SSL VPN server 114 then rewrites the packet's destination address by replacing the virtual IP address by the client IP address (192.168.1.1) (DNAT). The SSL VPN server 114 encapsulates the packet and forwards it into the SSL tunnel 118₁ (as per the static route) for transmission to the client machine 108₁. Upon exiting the SSL tunnel 118₁, the outgoing tunnel packet is decapsulated by the SSL VPN client 112₁ and routed to the client machine 108₁ according to the destination address (192.168.1.1) found in the packet.

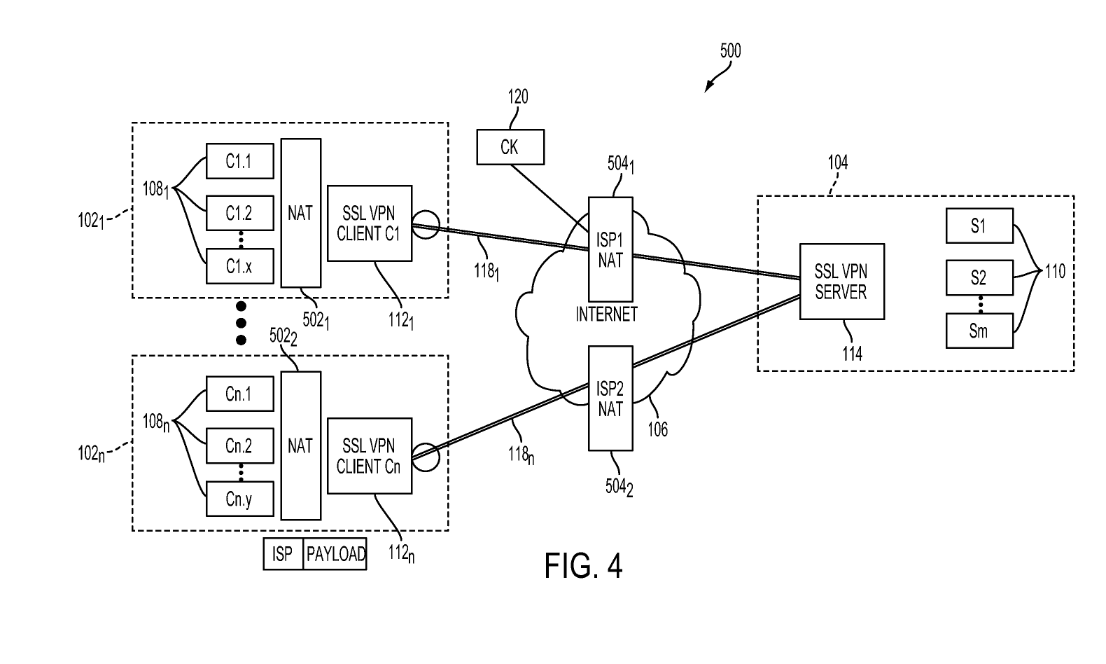

FIG. 4 illustrates an SSL VPN system 500 in accordance with a second embodiment. The system 500 comprises similar elements as the system 100 of FIG. 1 (denoted by the same reference numerals) but the client machines 108₁, . . . , 108ₙ, are each located behind one or more NAT devices 502₁, . . . , 502ₙ. Internet Service Provider (ISP) NAT devices 504₁, . . . , 504ₙ may also be provided at the network 106. Each one of the NAT devices 502₁, . . . , 502ₙ and the ISP NAT devices 504₁, . . . , 504ₙ is used to modify network address information in packets while the packets are routed, as will be described further below. It should be understood that, although both NAT devices 502₁, . . . , 502ₙ and ISP NAT devices 504₁, . . . , 504ₙ are illustrated and discussed herein, only NAT devices 502₁, . . . , 502ₙ or only ISP NAT devices 504₁, . . . , 504ₙ may be provided in the system.

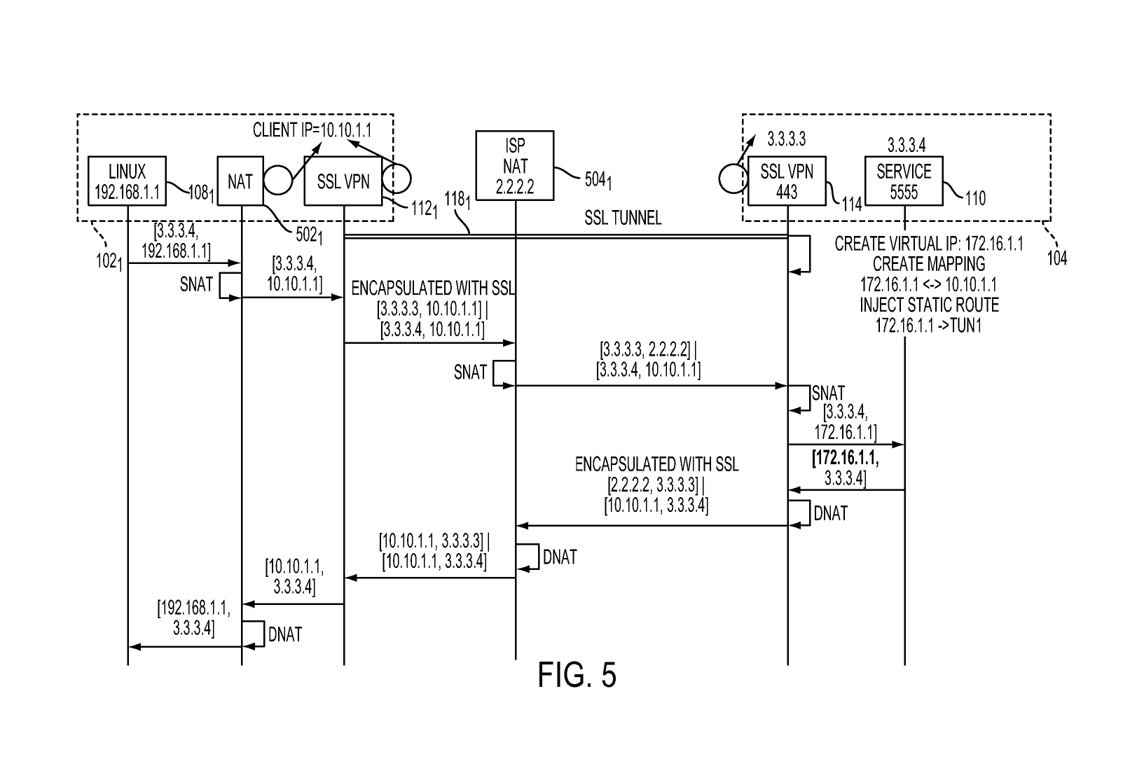

FIG. 5 illustrates an example of SSL VPN establishment, in accordance with a second embodiment. The example of FIG. 5 is similar in some aspects to the example of FIG. 3 (and therefore uses similar reference numerals for corresponding elements). Still, in FIG. 5, the remote network 102₁ comprises a NAT device 502₁ behind which the client machine 108₁ is located. The NAT device 502₁ may have the same IP address (10.10.1.1) as the SSL VPN client 112₁, as illustrated, or a different IP address. An ISP NAT device 504₁ having an IP address 2.2.2.2 is further provided. Once the SSL VPN tunnel 118₁ is established, a mapping is established between the virtual IP address (172.16.1.1), the IP address of the NAT device 504₁ (which is the packet's source address), and the SSL tunnel 118₁, and a static route is created. It should be understood that, in some embodiments, the NAT IP address may be the same as the SSL VPN client IP address. A packet sent into the remote network 108₁ by the client machine 108₁ is received by the NAT device 502₁, which performs SNAT, i.e. rewrites the packet's source address to a different value, i.e. replaces the IP address (192.168.1.1) of the client machine 108₁ by its own IP address (10.10.1.1). The packet is then passed to the SSL VPN client 112₁, where it is encapsulated. The encapsulated packet is routed into the SSL tunnel 118₁ and received by the ISP NAT device 504₁, which performs SNAT, i.e. modifies the source field of the packet's header to replace the client IP address (10.10.1.1) by its own IP address (2.2.2.2). In order to reflect the change, the ISP NAT device 504₁ may also alter the header checksums that are provided in the packet for error detection.

The encapsulated packet then exits the SSL tunnel 118₁ and is received by the SSL VPN server 114, which decapsulates the packet, queries the memory to determine from the mapping the virtual IP address (172.16.1.1) that corresponds to the packet's source address (i.e. the client IP address 10.10.1.1), and rewrites the packet's source address by replacing the client IP address with the virtual IP address. The resulting packet is then sent to the server 110, which accordingly generates an outgoing packet having as its source address the IP address (3.3.3.4) of the server 110 and as its destination address the virtual IP address (172.16.1.1). The outgoing packet is then sent by the server 110 to the SSL VPN server 114, which rewrites the packet's destination address by replacing the virtual IP address with the client IP address (10.10.1.1). The SSL VPN server 114 then encapsulates the packet, which is forwarded into the SSL tunnel 118₁ for transmission to the client machine 108₁. The inverse operations to those described above (when discussing routing of a packet from the client towards the SSL VPN server 114) are then performed at the ISP NAT device 504₁, SSL VPN client 112₁, and NAT device 502₁, and the packet is received at the client machine 108₁.

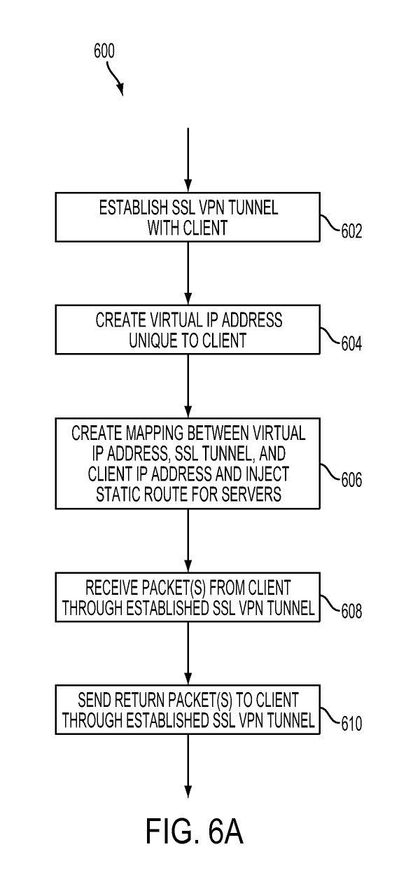

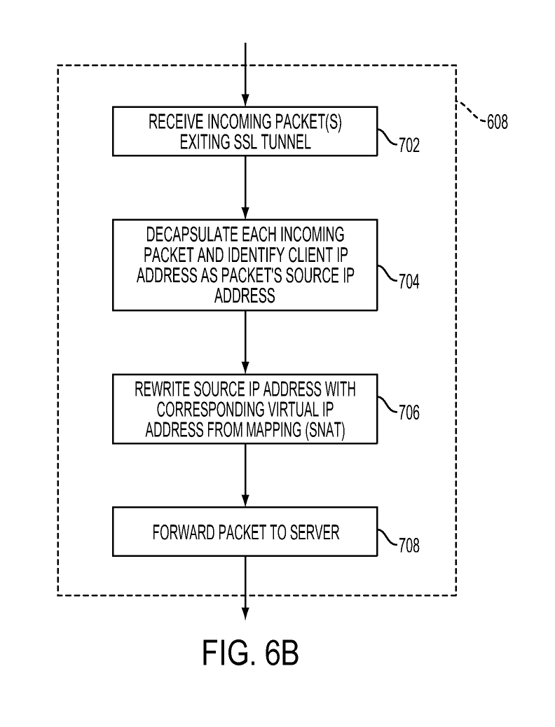

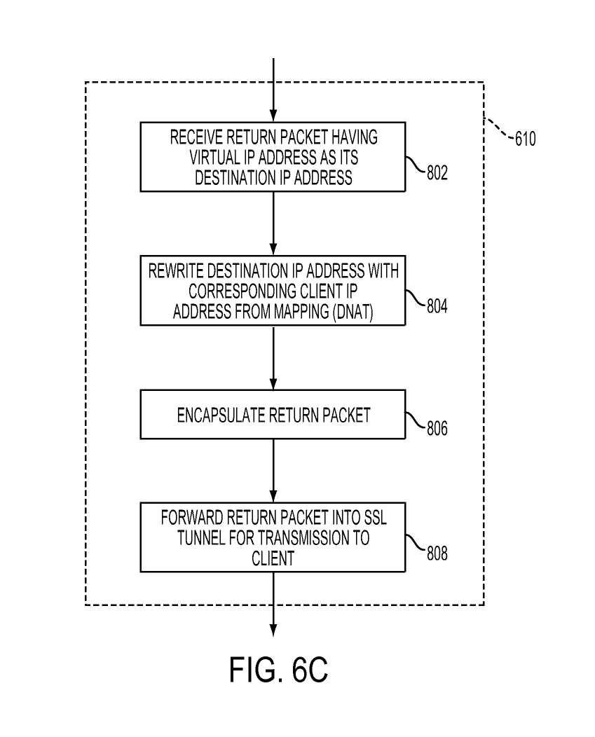

Referring now to FIG. 6a, a method 600 performed at the server side for communicating in an SSL VPN will now be described. The illustrated method 600 comprises establishing an SSL VPN tunnel with a client at step 602. A virtual IP address unique to the client is then created at step 604. A mapping between the virtual IP address, the SSL tunnel (e.g. the tunnel's identifier), and the IP address of the client is created at step 606. The client IP address may be the IP address of a client machine or the IP address of a NAT device the client is located behind, as discussed above. As also discussed above with reference to FIG. 2b, it should be understood that step 606 may be performed after a first packet is received from the client through the tunnel established at step 602. The step 606 may further comprise injecting a static route for the servers to indicate that outgoing packets, which are received from the servers and whose destination address is the virtual IP address, should be routed through the SSL VPN tunnel whose identifier is associated with the virtual IP address in the mapping created at step 606. Upon the client machine requesting access to the server, one or more packets may then be received from the client through the established SSL VPN tunnel at step 608 and outgoing packet(s) sent to the client through the tunnel at step 610.

Referring to FIG. 6b, the step 608 of receiving packet(s) from the client through the established SSL VPN tunnel comprises receiving at step 702 incoming packet(s) exiting the SSL tunnel. Each incoming packet is then decapsulated at step 704 whereby the client IP address may be identified as being the source IP address of the packet. The next step 706 is then to rewrite the source IP address of the incoming packet by replacing the client IP address with the corresponding virtual IP address from the mapping created at step 604, thereby performing SNAT. The resulting packet is forwarded at step 708 to a server for which an access request has been received from the client.

Referring now to FIG. 6c, the step 610 of sending outgoing packets to the client through the established SSL VPN tunnel comprises receiving (e.g. from the server) at step 802 an outgoing packet having as its destination IP address the virtual IP address. The next step 804 is then to rewrite the destination IP address of the packet by replacing the virtual IP address with the corresponding client IP address from the mapping created at step 606 of FIG. 6a, thereby performing DNAT. The outgoing packet is encapsulated at step 806 and forwarded at step 808 into the SSL tunnel for transmission to the client.

Using the systems and methods described above, it becomes possible to establish SSL VPN without requiring the SSL VPN server (reference 114 in FIG. 1) to perform IP address allocation and management for the SSL VPN clients (reference 112₁, . . . , 112ₙ in FIG. 1). Indeed, only a virtual address space that is local (i.e. internal) to the SSL VPN server 114 needs to be maintained and the SSL VPN clients 112₁, . . . , 112ₙ need not be configured with such virtual addresses. NAT can therefore be performed at the server side in a manner that is invisible to the client side. As a result, configuration overhead can be reduced and efficiency improved. Also, using the unique mapping between the virtual IP address, the SSL VPN tunnel identifier, and the client's IP address, the SSL VPN server 114 knows which SSL VPN tunnel to select for routing any given outgoing packet. Accordingly, since, after the mapping is performed, an outgoing packet exiting the SSL VPN tunnel at the client side has the client IP address as its destination address, the SSL VPN client (e.g. SSL VPN client 112₁ in FIG. 1) that serves as the tunnel's endpoint knows how to forward the outgoing packet. Moreover, client machines located in different remote networks (e.g. different enterprises or offices) can connect to the same SSL VPN server 114 to access the servers (reference 110 in FIG. 1), thereby increasing flexibility. In addition, the systems and methods described above are applicable to a variety of network topologies, whether NAT is provided or not at the client side or at the ISP level.

The above description is meant to be for purposes of example only, and one skilled in the relevant arts will recognize that changes may be made to the embodiments described without departing from the scope of the invention disclosed. For example, the blocks and/or operations in the flowcharts and drawings described herein are for purposes of example only. There may be many variations to these blocks and/or operations without departing from the teachings of the present disclosure. For instance, the blocks may be performed in a differing order, or blocks may be added, deleted, or modified.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. The structure illustrated is thus provided for efficiency of teaching the present embodiment. The present disclosure may be embodied in other specific forms without departing from the subject matter of the claims.

Also, one skilled in the relevant arts will appreciate that while the systems, methods and computer readable mediums disclosed and shown herein may comprise a specific number of elements/components, the systems, methods and computer readable mediums may be modified to include additional or fewer of such elements/components. The present disclosure is also intended to cover and embrace all suitable changes in technology. Modifications which fall within the scope of the present invention will be apparent to those skilled in the art, in light of a review of this disclosure, and such modifications are intended to fall within the appended claims.

What is claimed is:

1. A Secure Socket Layer (SSL) Virtual Private Network (VPN) server configured to:
assign a virtual Internet Protocol (IP) address to a selected client device having a client IP address associated therewith; and
map the virtual IP address to the client IP address and to a tunnel identifier of an SSL VPN tunnel.

2. The SSL VPN server of claim 1, further configured to:
receive through the SSL VPN tunnel a first incoming packet from the selected client device, the first incoming packet having the client IP address as a source address thereof and destined to a server device in communication with the SSL VPN server;
rewrite the source address of the first incoming packet with the virtual IP address mapped to the client IP address, thereby obtaining a first modified incoming packet; and
send the first modified incoming packet to the server device.

3. The SSL VPN server of claim 1, further configured to:
receive from a server device in communication with the SSL VPN server an outgoing packet having the virtual IP address as a destination address thereof, the outgoing packet for transmission to the selected client device over the SSL VPN tunnel;
rewrite the destination address of the outgoing packet with the client IP address mapped to the virtual IP address, thereby obtaining a modified outgoing packet; and
forward the modified outgoing packet into the SSL VPN tunnel.

4. The SSL VPN server of claim 1, further configured to maintain a virtual address space comprising a plurality of previously-generated virtual IP addresses and select an available one of the plurality of virtual IP addresses for assigning the virtual IP address.

5. The SSL VPN server of claim 1, further configured to dynamically generate the virtual IP address in real-time.

6. The SSL VPN server of claim 1, further configured to map the virtual IP address to the client IP address comprising an IP address of a client machine in communication with an SSL VPN device to which the SSL VPN tunnel is established.

7. The SSL VPN server of claim 1, further configured to map the virtual IP address to the client IP address comprising an IP address of a Network Address Translation (NAT) device in communication with an SSL VPN device to which the SSL VPN tunnel is established.

8. The SSL VPN server of claim 2, further configured to:
receive through the SSL VPN tunnel, after receiving the first incoming packet, a second incoming packet from the selected client device, the second incoming packet destined to the server device and having the client IP address as the source address thereof; and
rewrite the source address of the second incoming packet with the virtual IP address.

9. The SSL VPN server of claim 2, further configured to:
receive through the SSL VPN tunnel, after receiving the first incoming packet, a second incoming packet from another client device, the second incoming packet destined to the server device, the source address of the second incoming packet differing from the client IP address of the selected client device;
assign a new virtual IP address to the other client device and create a new mapping between the new virtual IP address, the tunnel identifier, and the source address of the second incoming packet; and
rewrite the source address of the second incoming packet with the new virtual IP address.

10. A method for communicating in a Secure Socket Layer (SSL) Virtual Private Network (VPN), the method comprising:
assigning a virtual Internet Protocol (IP) address to a selected client device having a client IP address associated therewith; and
mapping the virtual IP address to the client IP address and to a tunnel identifier of an SSL VPN tunnel.

11. The method of claim 10, further comprising:
receiving through the SSL VPN tunnel a first incoming packet from the selected client device, the first incoming packet having the client IP address as a source address thereof and destined to a server device in communication with the SSL VPN server;
rewriting the source address of the first incoming packet with the virtual IP address mapped to the client IP address, thereby obtaining a first modified incoming packet; and
sending the first modified incoming packet to the server device.

12. The method of claim 10, further comprising:
receiving from a server device in communication with the SSL VPN server an outgoing packet having the virtual IP address as a destination address thereof, the outgoing packet for transmission to the selected client device over the SSL VPN tunnel;
rewriting the destination address of the outgoing packet with the client IP address mapped to the virtual IP address, thereby obtaining a modified outgoing packet; and
forwarding the modified outgoing packet into the SSL VPN tunnel.

13. The method of claim 10, further comprising maintaining a virtual address space comprising a plurality of previously-generated virtual IP addresses, and wherein assigning the virtual IP address comprises selecting an available one of the plurality of virtual IP addresses.

14. The method of claim 10, wherein assigning the virtual IP address comprises dynamically generating the virtual IP address in real-time.

15. The method of claim 10, wherein the SSL VPN tunnel is established to an SSL VPN device and the virtual IP address mapped to the client IP address comprising an IP address of a client machine in communication with the SSL VPN device.

16. The method of claim 10, wherein the SSL VPN tunnel is established to an SSL VPN device and the virtual IP address mapped to the client IP address comprising an IP address of a Network Address Translation (NAT) device in communication with the SSL VPN device.

17. The method of claim 11, further comprising:
receiving through the SSL VPN tunnel, after receiving the first incoming packet, a second incoming packet from the selected client device, the second incoming packet destined to the server device and having as the source address thereof the client IP address; and
rewriting the source address of the second incoming packet with the virtual IP address.

18. The method of claim 11, further comprising:
receiving through the SSL VPN tunnel, after receiving the first incoming packet, a second incoming packet from another client device, the second incoming packet destined to the server device, the source address of the second incoming packet differing from the client IP address of the selected client device;
assigning a new virtual IP address to the other client device and creating a new mapping between the new virtual IP address, the tunnel identifier, and the source address of the second incoming packet; and
rewriting the source address of the second incoming packet with the new virtual IP address.

19. A computer readable medium having stored thereon program code executable by a processor for:
assigning a virtual Internet Protocol (IP) address to a client device having a client IP address associated therewith; and
mapping the virtual IP address to the client IP address and to a tunnel identifier of a Secure Socket Layer (SSL) Virtual Private Network (VPN) tunnel.
